(19) United States
(12) Patent Application Publication
(10) Pub. No.: US 2020/0156548 A1
(43) Pub. Date: May 21, 2020

(54) Reconfigurable Storage Tray for Vehicle

(71) Applicant: The Knapheide Manufacturing Company, Quincy, IL (US)

(72) Inventors: Christopher Weiss, Quincy, IL (US); Justin Steele, Quincy, IL (US); Mark Rose, Quincy, IL (US); Michael Bovee, Quincy, IL (US); Haily Meyer, Quincy, IL (US)

(73) Assignee: The Knapheide Manufacturing Company, Quincy, IL (US)

(21) Appl. No.: 16/385,232

(22) Filed: Apr. 16, 2019

Related U.S. Application Data
(60) Provisional application No. 62/769,019, filed on Nov. 19, 2018.

(51) Int. Cl. B60R 5/00

(52) U.S. Cl. CPC B60R 5/003

(57) ABSTRACT

A vehicle-mounted reconfigurable storage tray removably installed between two fixed storage cabinet walls in either a tray position or a shelf position. The storage tray includes right and left side panels and a bottom panel that has a tray surface on one side and a shelf surface on the other side. Mounting mechanisms are attached to each side panel, allowing the storage tray to be removably mounted on the inner walls of a storage cabinet.

### CROSS-REFERENCE TO RELATED APPLICATIONS

The present application claims priority from, and incorporates by reference in its entirety, provisional U.S. patent application Ser. No. 62/769,019 filed Nov. 19, 2018.

### TECHNICAL FIELD

Various embodiments of the present invention relate to container assemblies for vehicles, and more specifically, a reconfigurable tray suitable for mounting within a tool cabinet of a utility truck body.

### DESCRIPTION OF RELATED ART

Numerous types of vehicles are used to haul supplies, tools, spare parts or other like items. Maintenance vehicles, construction trucks, panel vans, delivery vehicles, and even farm trucks are examples of vehicles used to transport a myriad of different items. Such vehicles often have built-in storage cabinets. The storage cabinets may be further subdivided on the inside into a number of compartments or shelves to organize and more efficiently stow the contents.

Since vehicles are subjected to motion, vibration, acceleration and deceleration, the shelves of built-in vehicle storage cabinets must be securely fastened to the cabinet frame. There are several types of conventional shelf connection hardware. Some shelving systems have no sides and feature shelf holding braces that extend from behind the shelf to support each shelf from beneath. This type of shelving system may be open on the sides as well as the top and bottom, e.g. not contained within a cabinet. As such, this type of shelving system is not conducive for use in a vehicle. Parts, tools or supplies would not remain on the unenclosed shelves due to the motion and vibration of the vehicle. Shelving systems for vehicles are typically contained within a cabinet or tool box. Such shelving systems are called enclosed shelving systems.

Enclosed shelving systems come in two basic types of assemblies—movable wall shelf frames and stationary wall shelf frames. Movable wall shelf systems feature two side walls that are brought together around the shelf pieces during assembly of the shelving system. Many of the preassembled shelving furniture kits available for purchase are movable wall shelf systems. Some conventional truck mounted shelving is a type of movable wall shelf systems in which the shelves were bracketed in place during the assembly of the shelf system. The other type of enclosed shelving system—stationary wall shelf frames—feature stationary walls on the left and right sides of the shelves that are fixed in place relative to each other prior to installing the shelves. Each shelf is fastened between the two stationary walls. Conventional truck mounted shelving systems of this type—that is, stationary wall shelving systems—are either riveted or welded into place to avoid having the shelves come loose during transport and spilling the shelf s contents when the cabinet doors are opened.

### BRIEF SUMMARY

Various embodiments disclosed herein are drawn to vehicle-mounted reconfigurable storage trays suitable for being mounted onto the stationary interior side-walls of a truck mounted storage cabinet. The various embodiments of the reconfigurable storage tray include a bottom panel that has a tray bottom surface on one side and a shelf surface on the other side. The reconfigurable storage tray also has a pair of side panels attached to the bottom panel, and a pair of mounting mechanisms removably attached to each side panel.

The various embodiments are configured to be mounted between stationary walls in either a tray position with the tray bottom surface up or in a shelf position with the shelf surface up. The mounting mechanisms each have an insertion tab configured to extend into a hole in the stationary interior side-wall of the storage cabinet. The mounting mechanisms also each have a support tab extending from the mounting mechanism that is configured to support the weight of the storage tray.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A is a perspective view depicting an embodiment of the vehicle mounted reconfigurable storage tray positioned in the storage tray configuration.

FIG. 1B is a perspective view depicting an embodiment positioned in the shelf configuration.

FIG. 1C is a perspective view depicting a divider clip embodiment.

FIGS. 2A-B are perspective views depicting embodiments with a back panel having a different height than the front panel.

FIG. 2C are perspective views depicting three tray dividers according to various embodiments.

FIG. 2D is a perspective view depicting compartmentalized drawers mounted on reconfigurable shelves according to various embodiments.

FIG. 2E is a perspective view depicting pull-out bins mounted on a reconfigurable shelf according to various embodiments.

FIG. 2F depicts a front view of a sliding track and a cutaway portion of pull-out bin according to various embodiments.

FIG. 3A is a perspective cutaway view depicting mechanical mounting devices within a tool cabinet interior.

FIG. 3B-C depict perspective views of the mechanical mounting device of FIG. 3A along with a side view of the mechanical mounting device.

FIG. 4 depicts a cutaway perspective view of vehicle mounted reconfigurable storage trays installed in a utility truck body.

FIG. 5 is a flowchart depicting the assembly of the vehicle mounted reconfigurable storage tray according to various embodiments disclosed herein.

### DETAILED DESCRIPTION

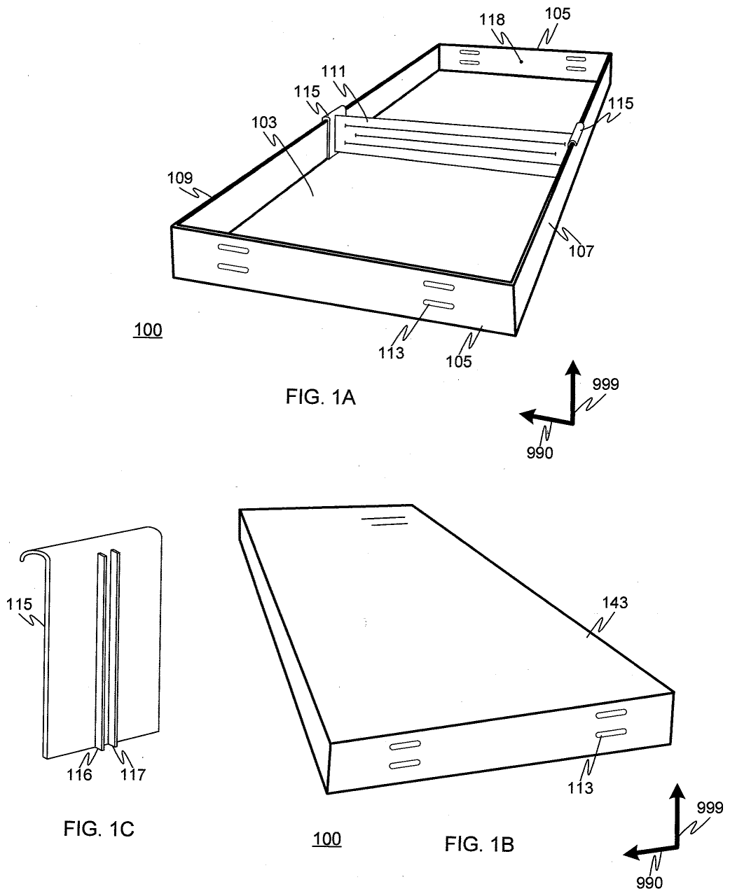

FIG. 1A is a perspective view depicting an exemplary embodiment of tray 100 positioned in the storage tray configuration. FIG. 1B depicts the same embodiment 100 as in FIG. 1A, except with tray 100 turned upside down to be positioned in the shelf configuration. To simplify the discussion herein, the embodiment 100 shown in FIG. 1B may be referred to as tray 100 in the shelf position, rather than calling it a shelf 100. The tray 100 in the shelf position shown in FIG. 1B has a shelf surface 143 that is parallel to the tray surface 103 of FIG. 1A. The tray 100 is typically constructed from a sturdy, rigid material such as steel, iron or aluminum, but may be made of a composite material, plastic, wood or other such materials as are known to those of ordinary skill in the art.

The reconfigurable storage tray embodiment 100 has two side panels 105, a bottom panel with a tray surface 103, a front side panel 107 and back side panel 109. The front side panel 107 is typically oriented towards the front of the cabinet near the doors that open to provide access to the cabinet interior. The side panels 105, the front side panel 107 and the back side panel 109 may be called vertical panels. The side panels 105 are typically configured parallel to each other and form the sides of the tray. The inner surfaces 118 of side panels 105 serve as the side surfaces of the tray. In some embodiments the side panels 105, front side panel 107 and back side panel 109 are all the same height as shown in FIGS. 1A-B. For references purposes, the reference arrow 999 in FIG. 1A and reference arrow 999 of FIG. 1B both depict the up direction—that is, away from the center of the earth. Reference arrow 990 of FIG. 1A and reference arrow 990 of FIG. 1B both point towards the “inward” direction with respect to the cabinet or tool chest in which the storage tray 100 is to be installed—that is, inward through the open doors of the cabinet or the opening through which a user accesses the tray or shelf.

The reconfigurable storage tray 100 may include one or more tray dividers 111 removably mounted on it. The tray dividers 111 may be configured to span between, the front and back panels 107-109. Tray dividers may also be provided to span between the side panels 105, between a side panel 105 and one of the tray dividers 111, or between two tray dividers 111. Corner tray dividers may also be provided to span between a side panel 105 and either front panel 107 or back panel 109. In the embodiment of FIG. 1A the tray divider 111 is movable, allowing a user to easily customize the reconfigurable storage tray 100 for holding various sized tools or supplies. In other embodiments the tray dividers 111 may be permanently attached (e.g., by welding, riveting or gluing) rather than being removably attached.

FIG. 1C is a perspective view depicting an embodiment of a divider clip 115 for removably mounting tray divider 111 to a storage tray 100 configured in the tray position. Typically, a divider clip 115 is positioned on each end of the tray divider 111 to securely, yet removably, affix the tray divider 111 to storage tray 100. The divider clips 115 may be made of various materials, depending upon the parameters and requirements of the particular implementation. For example, the divider clips 115 may be made of polyethylene, polyvinyl chloride or other type of plastic, aluminum, steel or other type of metal, a composite material, or other like types of materials known to those of ordinary skill in the art. In various embodiments the divider clip 115 may be designed with sufficient elasticity to snap into place on the front and back panels 107-109 (or side panels 105) of the storage tray 100 to aid in keeping the tray divider 111. Further, in various embodiments the tray divider 111 may be designed to be of sufficient length to fit snuggly between the divider clip 115 which themselves sit against the back panels 107-109 (or side panels 105) of the storage tray 100. This aids in keeping the tray divider 111 securely, yet removably, affixed in place within the storage tray 100.

Each divider clip 115 typically includes a groove, a notch, a track, or some other type of channel configured to receive the tray divider 111. FIG. 1C depicts a channel formed by channel sides 116-117. The channel sides 116-117 may be dimensioned such that they come in contact with each side of the tray divider 111. This provides an amount of pressure on the tray divider 111 to aid in keeping it in place without need for screws, bolts or other such threaded attachment mechanisms. Some embodiments, however, may be made even more secure through the use of threaded attachment mechanisms such as screws or bolts for attaching the divider clips 115 to either the back panels 107-109 (or side panels 105), or to the tray divider 111 itself.

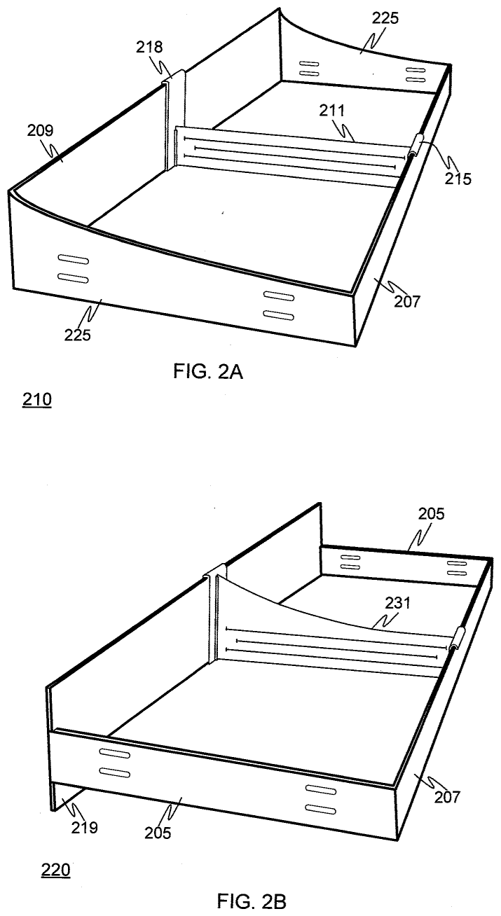

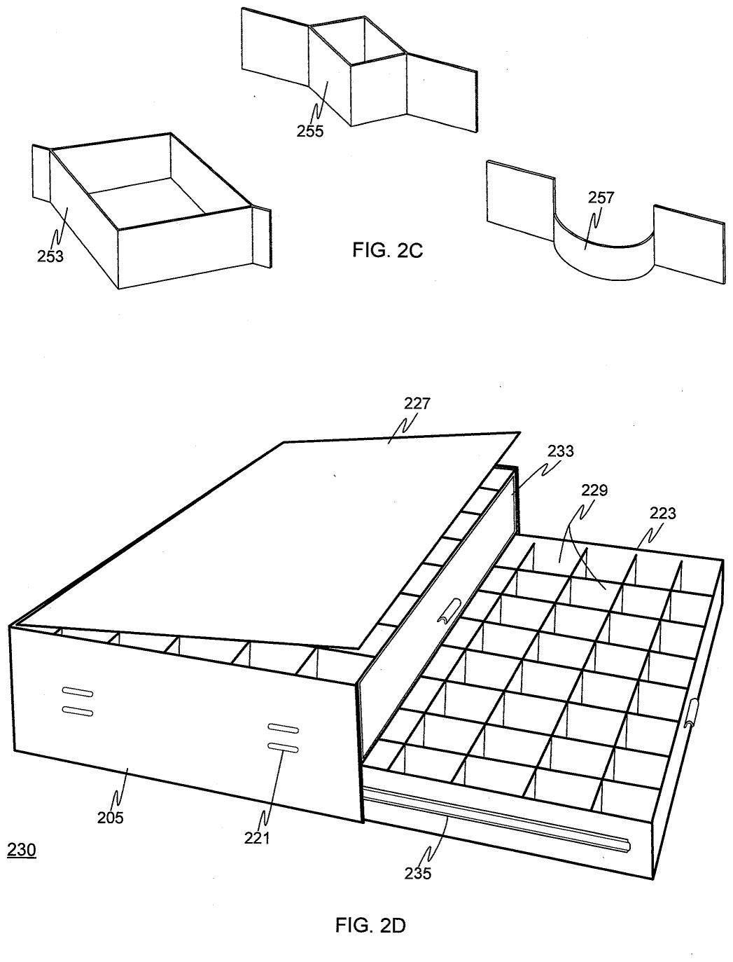

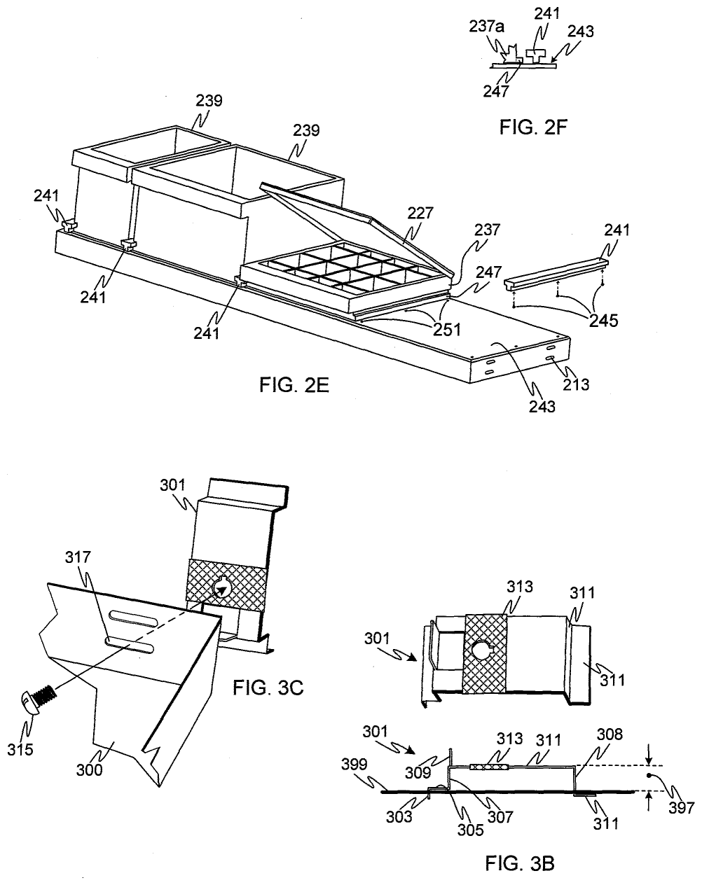

FIG. 2A is a perspective view depicting an embodiment 210 with a back panel 209 having a different height than the front panel 207. The embodiments shown in FIGS. 1A-B have front and back panels 107-109, side panels 105, and tray surface 103 that may be rectangular in shape and have a uniform height. In other embodiments, such as those depicted in FIGS. 2A-B, the side panels, front panel and back panel may be implemented to have different heights, and possibly different shapes. For example, in some embodiments the back panel 209 may be taller than the front panel 207 as depicted in embodiment 210 of FIG. 2A. The taller back panel 209 enhances the structural integrity of storage tray 210, while the shorter front panel 207 enables easier access to the storage tray 210 if there is a tray positioned above it. Further, in some embodiments the back panel need not be vertically flush with the shelf surface when the tray is mounted in the tray position with the tray surface facing up. Such an embodiment is shown in FIG. 2B which features the back panel 219 extending downward below the bottom surface of the tray. When the tray is flipped over in the shelf position that portion of the back panel 219 would extend upward above the shelf surface level, providing a back panel for the shelf.

Since the height of back panel 209 in FIG. 2A is greater than that of front panel 207 the height of divider clip 218 on the back panel may be greater than the height of divider clip 215 on the front panel. Typically, the divider clips are designed with a height that matches the panel to which is attached. In some implementations, for example as shown in FIG. 2A, the tray divider 211 is a uniform height from the front panel 207 to the back panel 209. In other implementations, for example as shown in FIG. 2B, the tray divider 231 may be a non-uniform height from the front panel 207 to the back panel 209. Moreover, as depicted in FIGS. 2A-B the tray dividers do not need to match the shape of the side panels. For example, a tray such as tray embodiment 220 may have rectangular side panels 205 and one or more non-uniform shaped tray dividers 231 as shown in FIG. 2B. Tray dividers of different shapes are useful for customizing the inside of the cabinet to hold specific tools or parts of various odd shapes. FIG. 2C depicts tray dividers 253-257 embodied in three different shapes. The tray dividers according to various embodiments may be implemented in a vast array of customized shapes and heights depending upon the requirements of the particular implementation.

Turning again to FIGS. 1A-B the front and back panels 107-109, side panels 105, and tray surface 103 may be rectangular in shape and uniform in height. However, for embodiments implemented with a back panel 209 having a different height than the front panel 207 as shown in FIG. 2A, the side panels may be implemented in shapes other than rectangular. FIG. 2A depicts side panels 225 shaped to span between the taller top edge of the back panel 209 to the lower top edge of front panel 207. On the other hand, some embodiments are implemented with side panels than do not connect with the top edge of the front and back panels. For example, embodiment 220 of FIG. 2B is implemented with side panels 205 that are the same height as front panel 207 but not connected with the top edge of taller back panel 209. In some embodiments the side panels may instead be the same height as the back panel. In yet other embodiments the side panels may be a height different from that of either the front panel or the back panel. It should be noted that the side panels, like the front and back panels, are not necessarily the same height or shape as compared to each other.

FIG. 2D is a perspective view depicting compartmentalized drawers mounted on reconfigurable shelves according to various embodiments. The reconfigurable storage tray embodiment 230 is configured to hold one or more compartmentalized drawers 223 and 233. The compartmentalized drawers 223 and 233 are typically mounted within a reconfigurable storage tray that is in the shelf position. The drawer mounting hardware of the compartmentalized drawers 223 and 233 depicted in FIG. 2D may be configured to compatible with commercially available drawers such as the Sortimo^{TM} brand drawer mounting hardware. In this particular figure, storage tray embodiment 230 contains two compartmentalized drawers 223. Other implementations may be configured with any number of drawers 223, depending upon the anticipated use and requirements of the implementations.

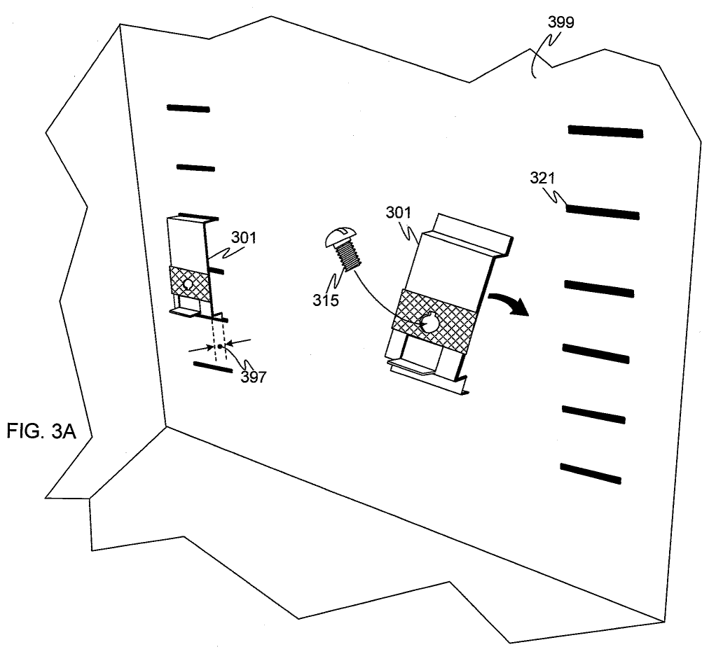

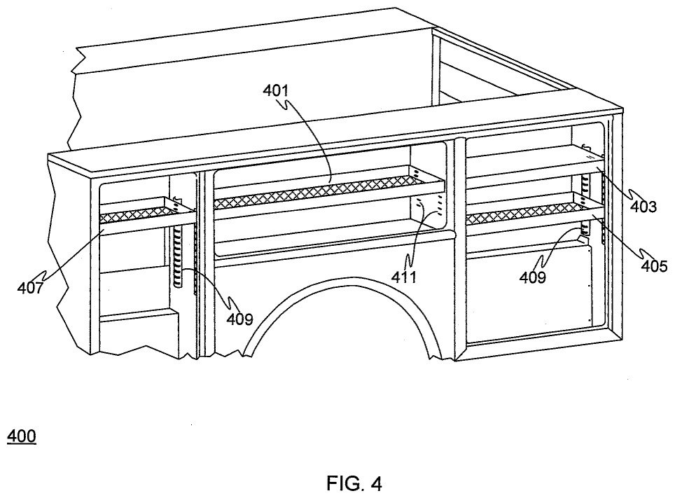

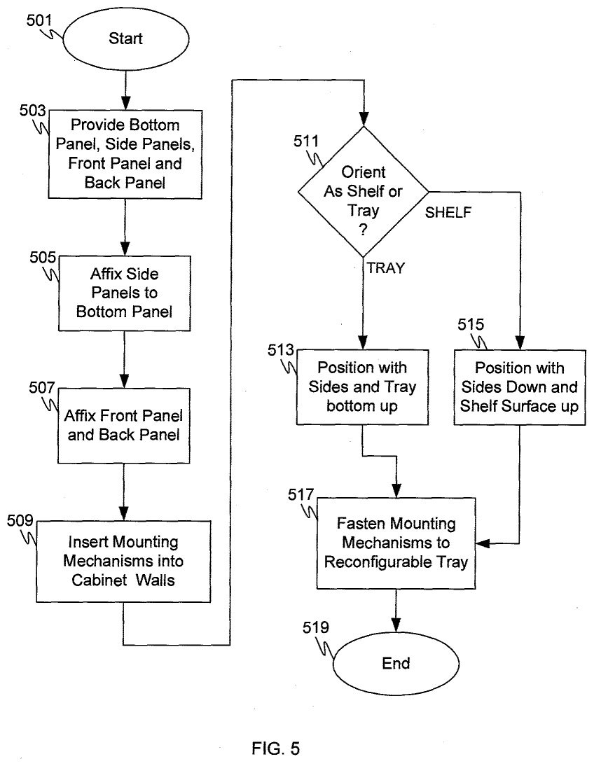

The reconfigurable storage tray embodiment 230 has holes or slots 221 in side panels 205 for mounting it within a cabinet enclosure. The methods and apparatus for mounting the reconfigurable storage tray is discussed in further detail below in conjunction with FIGS. 3A-C and FIG. 5. The embodiments 230 of the reconfigurable storage tray configured to receive one or more compartmentalized drawers 223 typically do not have a front panel (e.g., front panel 107 of FIG. 1A), thus allowing convenient access to the compartmentalized drawers. Some embodiments, however, feature a reconfigurable storage tray 230 with a front panel positioned below the level of the shelf to provide additional structural support while allowing clearance for the reconfigurable storage tray 230 to be pulled out like a drawer.

FIG. 2E depicts pull-out bins 237-239 mounted with a sliding mechanism on a shelf surface 243 of a reconfigurable storage tray. The pull-out bins 237-239 may be provided in a number of different configurations. For example, pull-out bins 239 are configured in the form of a four sided containers having two different widths. As such, reconfigurable pull-out bins 239 each have four sides and a bottom panel. In other implementations the front side may be shorter than the other three sides (or eliminated) to allow access to the pull-out bin 239 when it is slid inward, directly over the shelf surface 243. The pull-out bin 237 is a multicompartment tray with a hinging lid 227. In other embodiments the pull-out bin 237 may have multiple compartments of varying sizes or heights to customize it for holding certain tools or parts. In yet other embodiments the pull-out bin 237 may be equipped with a hinging lid 227 and have only a single compartment similar to pull-out bins 239.

The two pull-out bins 239 and pull-out bin 237 are mounted on the shelf surface 243 of a reconfigurable storage tray that attaches within the truck body tool cabinet. Typically, the reconfigurable storage tray with pull-out bins is attached within the tool cabinet in the shelf position, but may in some implementations, be placed in the tray position. The two pull-out bins 239 and 237 are mounted using a sliding mechanism in a manner that allows them to be pulled out like a drawer. In various embodiments the sliding mechanism may be implemented in several different forms. For example, FIG. 2E depicts sliding tracks 241 that affixes to the shelf surface 243 and slidably engages with a drawer rail component 247.

FIG. 2F shows a front view of a sliding track 241 next to a cutaway portion 237a of pull-out bin 237. The cutaway portion 237a has a sliding rail 247 configured to mate with sliding track 241, allowing the pull-out bin 237 to slide in and out relative to the shelf surface 243 like a drawer. The sliding rail 247 may either be formed on the pull-out bin 237 itself, or may be a separate component attached to the pull-out bin 237. In FIG. 2 F the sliding track 241 is shown apart from the sliding rail 247 for the purposes of illustration, so it can be seen how sliding rail 247 fits underneath the rim of track 241. The sliding tracks 241 may be removably affixed to shelf surface 243 with machine screws 245 that pass through holes 251 in the shelf surface 243 and screw into the sliding tracks 241. FIG. 2E depicts three machine screws 245 for each sliding track 241. Other implementations may use any number, one or more, of screws for each sliding track 241.

Instead of machine screws the sliding tracks 241 may be either removably affixed or permanently fastened with a number of other mechanical fastening means, including for example, bolts, screws, insertion pins, glue, adhesive tape, rivets, metal tabs, wire, welding, or other like types of mechanical fastening means known to those of ordinary skill in the art. Alternatively, in some embodiments the track 241 may be formed from the material of the shelf surface 243 itself rather than being implemented as a separate part. A track 241 or other sliding mechanism that is “on” the bottom panel (or shelf surface 243) may either be formed from the same piece of material as the bottom panel or may be attached to it.

Once the sliding tracks 241 are affixed to (or formed from) the shelf surface 243, the pull-out bins 239 and 237 are mounted onto shelf surface 243 so they can slide in and out like the drawers of a desk. Various embodiments may use other types of sliding mechanism aside from the sliding tracks 241. For example, some embodiments may use drawer sliding means including sliding tracks (as described above), roller tracks, extending roller tracks (similar to the mechanism often used on file cabinets), side mounted slide mechanisms, bottom center slide tracks, bottom center roller tracks, or other like types of drawer sliding means known to those of ordinary skill in the art.

The various embodiments provide a great degree of flexibility with respect to the manner of mounting different implementations of drawers and bins. Compartmentalized drawer 233 of FIG. 2D, shown in the closed position, and compartmentalized drawer 223 slide in and out on drawer tracks 235 affixed to either side of the drawers. Various embodiments may be implemented with other sliding mechanisms, including for example, rollers, wheels, guide rails, ribs and grooves, or other like types of structures suitable for drawer sliding hardware. In some embodiments the compartmentalized drawers 223/233 may be mounted on the shelf surface 243 as shown in FIG. 2E. In such embodiments a drawer track 241 or other type of other sliding mechanisms may be affixed to the shelf surface 243 to guide the compartmentalized drawers 223/233 as they are opened and closed. In other embodiments the sliding mechanisms may be mounted to the underside of a reconfigurable shelf, rather than the top side. This may be done using drawer mounting hardware, such as Sortimo™ brand tracks or other like type of sliding mechanisms suitable for slidably mounting a drawer or bin to a shelf.

The compartmentalized drawers 223 are typically removable from the reconfigurable storage tray 230 to conveniently allow parts or tools to be taken to the work site. In such embodiments the compartmentalized drawers 223 may simply be pulled out. of the reconfigurable storage tray 230, and later be reinserted. The compartmentalized drawers 223 may be configured with a number of compartments 229 for storing small parts, tools or other materials. There may be any number of compartments 229, depending upon the requirements of the implementation—e.g., from as few as one to several dozen. The compartments 229 may all be the same size as shown in FIG. 2D, or may be different sizes or shapes, customized to hold particular tools or materials. The compartmentalized drawers may be configured with a lid that is either attached and hinges to open revealing the compartments, or is removable. For example, lid 227 shown in FIGS. 2D-E is mounted on compartmentalized drawer 233. The lid 227 may be typically provided with a latch mechanism to removably secure it to the compartmentalized drawer 233. Other embodiments of the compartmentalized drawers, for example compartmentalized drawers 223, may omit the lid.

FIG. 3A is a perspective cutaway view depicting mechanical mounting mechanisms 301 within a tool cabinet interior including cabinet wall 399 and a cutaway portion of an interior cabinet wall such as that of the cabinet above the wheel well depicted in FIG. 4. The mechanical mounting mechanism is removably attachable to cabinet wall 399, and configured to support storage tray 300. The storage tray 300 may be a portion of storage tray 100 depicted in FIG. 1A. The present inventors recognized that a tray or shelf mounted on a moving vehicle (e.g., a maintenance truck) is subject to environmental rigors not experienced by a similar tray mounted in a fixed location such as the wall of a garage. Conventional shelves in a stationary cabinet (e.g., a tool cabinet in a building) typically sit on top of shelf pegs extending under both ends of the shelf. While such a system is easy and inexpensive to manufacture, a shelf sitting on conventional shelf pegs is not suitable for use in a motor vehicle. A conventional shelf sitting on shelf pegs can easily be displaced if subjected to vibrations or motion. The shelf pegs do not hold the shelf in place. A vehicle-mounted storage tray must withstand vibration, accelerations, decelerations, bouncing, jostling and various other motions and disturbances as the vehicle moves. In this environment, a conventional tray mounted on shelf pegs would eventually come loose due to the jostling motion, causing tools, parts and other supplies to spill within the cabinet or possibly fall out upon opening the cabinet door.

The conventional approach for vehicle-mounted shelving systems is to weld or rivet the shelves in place. This approach, the present inventors recognized, has drawbacks as well. A shelf permanently affixed in place with welding or rivets cannot be removed or adjusted to a different position. Another conventional solution is to use threaded bolts to support the weight of the shelf and hold the shelf in place. While this may allow the shelf to be removed, the disadvantages of using threaded bolts to hold the shelf in place are twofold. First, the threaded bolt holes that aren't in current use tend to collect dirt, rust and grime over time, which may eventually render them difficult or even impossible to use when the time comes to adjust the shelf to a new position. Second, a conventional adjustable shelf using bolts and bolt holes requires a threaded bolt hole at each position to which it can be adjusted. Threaded bolt holes tend to be more expensive, have tighter tolerances, and take more time to manufacture than a series of slots or non-threaded holes.

The various embodiments of the removable storage tray disclosed herein overcome the aforementioned drawbacks of conventional systems, and afford other advantages and benefits. FIGS. 3A-B depict an embodiment of a mechanical mounting device that does not rely on bolts and threaded bolt holes to support the tray's weight inside of the tool cabinet. The mechanical mounting mechanism of FIGS. 3A-B is a type of 3D-fixed connector mechanism. Stationary wall shelf systems may be categorized by the type of connector mechanism used to hold the shelves as either fixed connector mechanisms or gravity rest connections. A fixed connector mechanism won't allow movement of the tray in the vertical direction. While fixed connector mechanisms won't allow the shelf to be lifted up, some implementations of fixed connector mechanisms may allow the shelf to be pulled out. A 3D-fixed connector mechanism won't allow the shelf to be lifted up or pulled out, keeping the shelf stationary in all three dimensions with respect to the shelving frame during the vibration, acceleration, deceleration and movement of the vehicle. By contrast, a shelf resting in place between gravity rest connections (e.g., shelf pegs) may be lifted from its position and removed from the shelf frame.

The various embodiments disclosed herein are drawn to one or more shelves assembled between two stationary side walls. As such, the various embodiments pertain to enclosed stationary wall shelf systems that are both reconfigurable and adjustable. Conventional movable wall shelf systems do not pertain to the embodiments disclosed herein since such conventional systems can only be assembled by sandwiching the walls around the shelves during fabrication. The various embodiments are reconfigurable in as much as the trays may be flipped and reinstalled as shelves, and vice versa. The various embodiments are adjustable in as much as the shelves/trays can conveniently be adjusted up or down to accommodate materials of differing sizes.

Turning again to FIG. 3A, the interior cabinet wall 399 is a fixed side wall of the truck mounted tool cabinet. A fixed cabinet wall such as cabinet wall 399 are not moved to accommodate assembly of a shelving structure to be contained within it. Each of the fixed connection mounting mechanisms 301 inserts into a pair slots 321 in wall 399. Each side the tray—for example, the left and right sides 105 of storage tray 100 of FIG. 1A—are affixed to and supported by a pair of the mounting mechanisms 301. Each of the mounting mechanisms 301 is a fixed connection in as much as it “fixes” the tray in place with respect to the shelving frame (e.g., cabinet wall 399) once the tray is installed. To be more specific, each of the mounting mechanisms 301 is a 3D-fixed connector mechanism.

In various embodiments two or more mounting mechanisms 301 (FIG. 3A-B) fasten to a side panel of the tray (e.g., side panel 105 of FIG. 1A) to support and affix the tray to the cabinet wall 399. In other embodiments three or more mounting mechanisms 301 may be implemented to support each side of the tray. In other embodiments one mounting mechanism 301 may be implemented to support a side of the tray. For example, in one embodiment the mounting mechanism spans between the two rows of slots on the cabinet wall 399. Further, in some embodiments one or more mounting mechanisms 301 may also be affixed to the back wall of the tool cabinet to provide further support to the tray, and in particular, provide support towards the center of the tray.

The slots 321 depicted in FIG. 3A are approximately 1 inch apart. However, to provide more positions for adjusting the height of the tray the slots 321 may be spaced more closely together. If fewer positions are desired the 321 slots may be spaced further apart. In various embodiments the slots 321 may be spaced as closely together as 0.25 inch or as far apart as desired. The only constraint is that pairs of slots within the same row must be spaced apart the correct distance to accept mounting mechanism 301. For example, in embodiments in which the insertion tabs 303 of a mounting mechanism 301 are 2 inches apart, then there must be a pair of slots 2 inches apart also to accept the insertion tabs 303. There can, however, be one or more additional slots between the pair that are 2 inches apart in order to provide more positions for adjusting the tray, as shown in FIG. 3A.

Slots 321 are formed in interior wall 399 of the tool cabinet, as shown in FIG. 3A. The slots need not be rectangular slots as shown in the figure. The slots may be elongated slots as depicted in FIG. 3A (with either rounded ends or squared ends), round holes, square holes, or any other shaped hole known to those of ordinary skill in the art, so long as the respective cross-sections of insertion tab 303 and standoff arm 308 each matches the shape of the hole into which it is to be inserted in cabinet wall 399. Furthermore, the embodiment depicted in FIG. 3A shows one insertion tab 303 at each end of the mounting mechanism 301. However, some embodiments have two or more insertion tabs 301 (or rods, pins, etc.) at each end of the mounting mechanism 301 and corresponding slots or holes configured to accept the two or more insertion tabs 301 (or rods, pins, etc.).

FIG. 3B depicts a perspective view of the mechanical mounting mechanism 301 of FIG. 3A along with a side view of mounting mechanism 301. Mounting mechanism 301 has standoff arms 307 and 308 that provide spacing between the clip body 311 and the cabinet wall 399. Standoff arms 307 and 308 typically provide from 0.1 to 0.5 inches of space between the clip body 311 and the cabinet wall 399. However, standoff arms 307 and 308 of various dimensions may be implemented to position the clip body 311 as close as adjacent (0 inches) to whatever is standoff distance is needed for the implementation. As a practical matter, the standoff arms 307 and 308 are generally less than 10 inches. Standoff arms 307 and 308 that are greater lengths are implemented with a clip body 311 of commensurate dimensions to provide additional leverage for supporting the weight of the shelf.

The mounting mechanism 301 is configured with a support tab 309 that supports the underside of a tray installed on it. Mounting mechanism 301 has an insertion tab 303 that fits into one of the slots 321 of cabinet wall 399. The standoff arm 308 also fits into another of the slots 321. Insertion tab 303 and/or standoff arm 308 support the weight placed on the mounting mechanism 301. The standoff distance 397 is the distance from the cabinet side wall 399 to the surface of clip body 311. The outside width dimension of the shelf (or tray) is slightly less than the interior cabinet width minus two times the standoff distance 397. It is slightly less so the shelf (or tray) can fit between opposing mounting mechanisms 301 one the left and right interior cabinet side walls 399. During assembly before tightening down the machine screw 315 there may be a slight amount of horizontal play in the assembly. The horizontal play in the assembly is the distance the shelf (or tray) can move left and right upon being assembled. The amount of horizontal play in the assembly is less than the distance that insertion tab 303 inserts into slots 321, sometimes called the insertion distance.

A tray clip 313 may be provided on the surface of mounting mechanism 301 to accept a mechanical fastener such as a rivet, a bent tab, a threaded attachment mechanism or other like type of mechanical fastener known to those of ordinary skill in the art. The threaded attachment mechanism may be implemented as a sheet metal screw, a machine screw 315, a bolt or other threaded attachment mechanism to secure the tray to the mounting mechanism 301. It should be noted that the machine screws or bolts used to attach the mounting mechanism 301 do not support the weight of the tray. Rather, the machine screw 315 merely secures the tray to mounting mechanism 301 in the horizontal direction. The weight of the tray is borne by the support tab 309. Thus, the various embodiments disclosed herein differ from the conventional solution of using threaded bolts to support the weight of the shelf and hold the shelf in place discussed above in conjunction with FIG. 3A.

The tray clip 313 is configured to receive the machine screw 315 (or other mechanical fastener) that has been inserted through a hole or slot in the side of the shelf or tray. This fastens the shelf securely in place. For example, FIG. 3C depicts machine screw 315 configured to be inserted through shelf slot 317 and threaded into tray clip 313. Typically, the tray clip 313 slides onto the mounting mechanism 301, and may be free to move a bit up and down to align with the hole or slot 113 on the tray 100 shown in FIG. 1A-B. Tightening the machine screw 315 to tray clip 313 takes the play out of the components, securely affixing the storage tray 300 to the cabinet wall 399 in the manner of a 3D-fixed connector mechanism. Other embodiments are implemented without a tray clip 313, for example, instead having a threaded hole in the body of the mounting mechanism 301 to accept a sheet metal screw, a machine screw 315, a bolt or other type of threaded attachment mechanism. Other mechanical means to removably attach the mounting mechanism 301 to the side of the tray include a spring steel clip, a hasp, a pin and metal loop, a bolt and nut or other like types of removable attachment means known to those of ordinary skill in the art.

The various embodiments are reconfigurable in two respects. First, the tray may be mounted tray side up as depicted in FIG. 1A, or may be mounted shelf side up as depicted in FIG. 1B. Second, the rows of slotted holes 321 allow the trays within a storage cabinet to be moved up or down to accommodate different sized articles, or to insert more or fewer trays within the cabinet. Typically, the storage tray 100 depicted in FIGS. 1A-B is mounted within a storage cabinet with the tray surface 103 parallel to the ground, that is, flat. However, in some embodiments the tray surface 103 may be installed at an angle other than flat to accommodate odd shaped tools or materials, for example, slanted from one side to the other or from front to back or back to front. Moreover, the surface 103 is depicted in FIGS. 1A-B and 2A-B as being planar. However, various embodiments of the vehicle-mounted reconfigurable storage tray disclosed herein may be configured with a tray surface or a shelf surface shaped other than flat to accommodate the storage of odd shaped tools or materials. For example, the tray surface or a shelf surface may be concave shaped, convex shaped, shaped like a portion of a cylinder, trough shaped, or other like shapes known to those of ordinary skill in the art.

FIG. 4 depicts a cutaway perspective view 400 of different sized vehicle mounted reconfigurable storage trays installed in a utility truck body. Reconfigurable storage trays according to various embodiments may be implemented in a number of different lengths and dimensions. Storage tray 401 spanning the tool cabinet above the truck body wheel well is considerably longer than trays 403, 405 or 407. A typical reconfigurable storage tray according to various embodiments may have a tray surface that is 36 by 16 inches. In some implementations the storage tray may be as wide as 10 feet or as narrow as three inches, or any dimension in between these two extremes. In some implementations the storage tray may be a depth (the side 105 length of FIG. 1A) of as much as four feet to as little as two inches, or any dimension in between these two extremes.

Storage trays 401, 405 and 407 are mounted in the tray position with sidewalls extending upward to hold small parts and tools. Tray 403 is mounted in the shelf position with its flat surface upward. The versatility of the various embodiments allows a user to flip the storage trays, for example, so that trays 401, 405 and 407 are mounted in the shelf position and tray 403 is mounted in the tray position.

The truck body depicted in FIG. 4 has a number of rows of slotted holes 411 configured within the tool cabinet interiors, and also has a number of slotted hole strips 409 mounted in other locations with the tool cabinet interiors. Typically a slotted hole strip 409 is mounted on an interior cabinet wall on the other side of the outside wall of the tool cabinet. For example, the right side of trays 403 and 405 are mounted on an interior cabinet wall towards the back of the vehicle. A strip of slotted holes drilled in that rear wall would result in holes through to the outside of the vehicle, near the vehicle's brake lights. This would look unsightly and also allow moisture through the rear wall into the tool cabinet. Therefore, a pair of slotted hole strips 409 is mounted on the rear interior cabinet wall to avoid holes through the tool cabinet to the outside. The slotted hole strips 409 are considered part of the interior cabinet wall for the purposes of determining the interior cabinet width.

For interior tool cabinet walls—such as the walls to the right and left of the wheel well—a row of slotted holes 411 may be used on one side of the wall with slotted hole strips 409 being used on the other side of the wall. This is often done because the insertion tabs 303 (shown in FIG. 3B) extend through the slotted holes 411. Configuring a slotted hole strip 409 on the opposite side of the wall from the slotted holes 411 allows the insertion tabs 303 to extend through the holes into the space behind the slotted hole strip 409.

FIG. 5 is a flowchart depicting the assembly of the vehicle mounted reconfigurable storage tray according to various embodiments disclosed herein. The method begins at 501 and proceeds to block 503 to obtain the shelf's bottom panel, the side panels, the front panel and the back panel. In various embodiments the five panels are rectangular in shape. However, in some embodiments the panels may be shapes other than rectangular. For example, as discussed above in conjunction with FIG. 2A the side panels may be implemented in shapes other than rectangular to as to connect front and back panels that of different heights. Other panels may be not rectangular as well. The back panel may be higher in the middle than the ends in order to provide increased structural strength. The bottom panel may curve inward somewhat, from front to back, in order to provide clearance between the tray and cabinet door(s) for storage of tools or materials just inside the door. The front panel of the tray may be curved downward towards the center in order to ease access to tools or materials stored in the tray. Those of ordinary skill in the art know various other shaped panels that may be used for the reconfigurable storage tray.

Once, the various panels have been provided in block 503 the method proceeds to 505 to arrange the side panels on the bottom panel. In block 507 the front and back panels are arranged on the bottom panel. Typically, the side panels, the front panel and the back panel are permanently affixed by being welded, glued or riveted to the bottom panel. The side panels and front/back panels may be cut may also be removably affixed by bolting or screwing them on to the bottom panel. In other embodiments the side panels and front/back panels may be arranged on the bottom panel by cutting them from the same piece of material as the bottom panel, and simply bent them upward or downward to shape. Front, back or side panels that are made from the same piece of metal as the bottom panel (e.g., by bending the front, back or side panels to shape) are considered to be arranged to the bottom panel. For example, a bottom panel cut extra wide may have side panels “attached” to it by bending the extra bottom panel material upwards (or downwards) to form the side panels. The side panels in this implementation are considered attached even though they are formed from the same piece of material as the bottom panel.

Upon completing block 507 the method proceeds to block 509 to insert the mounting mechanism into slotted holes formed within the cabinet walls, or at least proximate the cabinet interior walls. That is, the slotted holes are either holes directly in the cabinet walls themselves, or are holes in a slotted hole strip (e.g., 409 of FIG. 4) that, being mounted on the cabinet wall, is proximate the cabinet wall. Once block 509 is completed and the mounting mechanisms are mounted on the stationary interior tool cabinet wall, the method proceeds to block 511.

In block 511 it is determined whether the reconfigurable storage tray will be mounted in the tray position or the shelf position. If the tray is to be mounted in the tray position the method proceeds to block 513 and the reconfigurable storage tray is oriented with the tray sides upward. If the tray is to be mounted in the shelf position the method proceeds to block 515 and the reconfigurable storage tray is oriented with the tray sides down and the shelf surface up. In either case the reconfigurable storage tray is placed on the support tabs of the mounting mechanism that extend outward to receive the lower side of the tray and support its weight.

The method then proceeds to block 517 to fasten the mounting mechanisms to the reconfigurable storage tray. This may be done with a threaded attachment mechanism such as machine screws 315 of FIG. 3A, or with other like types of mechanical fasteners. Once the reconfigurable storage tray is fastened to the mounting mechanism in block 517 the method proceeds to block 519 and ends.

Some of the activities may be included or excluded as described above, or performed in a different order as is known by those of ordinary skill in the art, while still remaining within the scope of at least one of the various embodiments. For example, in the case of the sides, the front side and the back side being cut from the same piece of material as the bottom panel, it not necessary to perform the activities in blocks 505 and 507—since the side panels and front/back panels are already affixed to the bottom panel. As another example, the activity of inserting the mounting mechanisms into the cabinet walls in block 509 may be performed at any time prior to block 517. One of ordinary skill in the art would know that other activities may either be omitted or performed in a different order than that depicted in FIG. 5.

The terminology used herein describes the embodiments outlined in this specification, and is not intended to limit the invention. The terms “up” or “upward” refer to a direction tending away from the center of the earth. The terms “directly up” or “directly upward” refer to the direction straight upward away from the center of the earth. The phrases “removably attached”, “removably affixed” or “removably mounted”, as used herein, mean a part (or mechanism, component device, unit etc.) that can be attached to another part, and later removed without destroying or damaging either part or the mechanism for removably attaching the two pieces. For example, a threaded nut is removably attachable from a bolt. A king bolt is removably attachable to a wagon tongue. However, one piece of metal welded onto another piece of metal is not removably attached. Also, one part that is riveted onto another part is not considered to be removably attached since the rivets must be destroyed to separate the two parts. Two parts that are “permanently attached” or “permanently affixed”, as used herein, are attached in a manner that is not conducive to separating the parts without damaging one part or the other, or damaging the means of attaching them together. Two parts may be “permanently attached” (or “permanently affixed”), for example, by being welded, glued or riveted together. Further two parts that are formed from the same piece of material are considered to be permanently attached together. For example, tray side panels formed from the same piece of metal as the tray bottom are considered to be permanently attached to the tray bottom. The term “arranging” can mean either attaching to or forming on. For example, a front panel arranged on the bottom panel can either be attached to the bottom panel or can be formed from the same piece of metal as the bottom panel.

The phrase “threaded attachment mechanism” as used herein is defined to mean a bolt, a machine screw, a screw, a threaded rod, or other like type of elongated part with threads configured to be screwed into a threaded hole or other hole as are known by those of ordinary skill in the art. “Cutting” a hole in a piece of material (e.g., a panel) can be achieved by drilling, sawing, melting with a blow torch, cutting with a laser or otherwise removing some material from the piece of material so as to create a hole.

To simplify the explanation in this specification the reconfigurable trays according to various embodiments may be referred to as “trays” in the various sections regardless of whether they are mounted in the tray position (FIG. 1A) or in the shelf position (FIG. 1B). Various embodiments of bins are disclosed herein, for example, the pull-out bins 237-239 of FIG. 2E. The “bins” may also be called drawers, compartments, boxes or other like terms. The phrase “at least proximate” refers to a components location relative to another item. For example, a hole that is “at least proximate” to an item means that the hole on a part mounted on the item, or else hole that is on the item itself. For example, a slotted hole at least proximate the interior wall of a cabinet includes both a slotted hole within a slotted hole strip (e.g., 409 of FIG. 4) mounted on the interior wall, and also a slotted hole formed in the interior wall itself. “At least proximate” can also mean within a distance no greater than the largest dimension of the thing itself For example, a 1 inch long slotted hole in a slotted hole strip is at least proximate an interior wall of a cabinet so long as the slotted hole is within 1 inch of the interior wall (even if the slotted hole is in a slotted hole strip that is not mounted directly on the interior wall). For the purposes of this disclosure, two components formed from the same piece of material are considered to be “attached”. For example, in some embodiments the front panel is formed from the same piece of sheet metal as the bottom panel, and simply bent to shape. In such embodiments the front panel is considered to be “attached” to the bottom panel, even though the two components were formed from the same piece of material: The act of bending the front panel up from the bottom panel is considered to be “attaching” the front panel to the bottom panel.

As used herein, the singular forms “a”, “an” and “the” are intended to include the plural forms as well, unless the context clearly indicates otherwise. It will be further understood that the terms “comprises,” “comprising,” “includes,” and/or “including” used in this specification, including the claims, specify the presence of stated features, integers, steps, operations, elements, and/or components, but do not preclude the presence or addition of one or more other features, integers, steps, operations, elements, components, and/or groups thereof. The terms “obtaining” or “providing”, as used herein and in the claims, means to retrieve an article or device to be assembled as part of the apparatus at issue. Further, the terms “obtaining” or “providing” may be defined to mean fabricating, or adapting another part to operate as the article or device. For example, bending up the ends of a bottom panel to form side panels can be interpreted as providing side panels attached to a bottom panel. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not included in the “plurality” and are therefore, not referred to by “each.”

The corresponding structures, materials, acts, and equivalents of any means plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope or gist of the invention. The various embodiments included for discussion herein were chosen and described in order to best explain the principles of the invention and the practical application, and to enable others of ordinary skill in the art to understand the invention for various embodiments with various modifications as are suited to the particular use contemplated.

What is claimed is:

1. A vehicle-mounted reconfigurable storage tray comprising:
a bottom panel including a tray surface on a first side of the bottom panel and a shelf surface parallel to the tray surface on a second side of the bottom panel;
a first side panel attached to the bottom panel, the first side panel including a first tray outer side-surface;
a second side panel attached to the bottom panel and configured parallel to the first side panel, the second side panel including a second tray outer side-surface; and
a back panel attached to the bottom panel;
wherein the vehicle-mounted reconfigurable storage tray is configured to be mounted in either the tray position with the tray surface up or a shelf position with the shelf surface up.

2. The vehicle-mounted reconfigurable storage tray of claim 1, further comprising:
a tray divider configured to be removably mounted on the vehicle-mounted reconfigurable storage tray in a tray position;
a front panel attached to the bottom panel;
first drawer mounting hardware affixed to a first inner surface of the first side panel; and
second drawer mounting hardware affixed to a second inner surface of the second side panel;
wherein the first drawer mounting hardware and the second drawer mounting hardware are configured to removably receive a compartmentalized drawer.

3. The vehicle-mounted reconfigurable storage tray of claim 1, further comprising:
a first mounting mechanism removably attached to the first side panel, the first mounting mechanism characterized by a first standoff distance and configured to be removably mounted on a first inner side-wall of a storage cabinet, the first inner side-wall being a stationary wall;
a first insertion tab extending from the first mounting mechanism and configured to bear a first weight portion of the vehicle-mounted reconfigurable storage tray, the first insertion tab configured to be inserted to at least an insertion depth into a first cabinet hole of the first inner side-wall of the storage cabinet;
a second mounting mechanism removably attached to the second side panel, the second mounting mechanism characterized by a second standoff distance and configured to be removably mounted on a second inner side-wall of the storage cabinet, the second inner side-wall being a stationary wall; and
a second insertion tab extending from the second mounting mechanism and configured to bear a second weight portion of the vehicle-mounted reconfigurable storage tray, the second insertion tab configured to be inserted to at least the insertion depth into a second cabinet hole of the second inner side-wall of the storage cabinet.

4. The vehicle-mounted reconfigurable storage tray of claim 3, further comprising:
a first panel hole through the first side panel and a second panel hole through the second side panel;
wherein the storage cabinet is defined by a cabinet width measured between the first cabinet hole and the second cabinet hole;
wherein the vehicle-mounted reconfigurable storage tray has a tray width measured from the first tray outer side-surface at the first panel hole to the second tray outer side-surface at the second panel hole; and
wherein the tray width plus the insertion depth plus the first standoff distance plus the second standoff distance is greater than the cabinet width.

5. The vehicle-mounted reconfigurable storage tray of claim 3,
wherein the first insertion tab comprises a flat surface configured to fit into the first cabinet hole, the first cabinet hole being an elongated slot; and
wherein the second insertion tab comprises a flat surface configured to fit into the second cabinet hole, the second cabinet hole being an elongated slot.

6. The vehicle-mounted reconfigurable storage tray of claim 5, wherein the bottom panel is planar; and
wherein the first cabinet hole is arranged on a slotted hole strip mounted on and considered part of the first inner side-wall of the storage cabinet.

7. The vehicle-mounted reconfigurable storage tray of claim 3,
wherein the first mounting mechanism and the second mounting mechanism are 3D-fixed connector mechanisms configured to keep the vehicle-mounted reconfigurable storage tray stationary in all three dimensions with respect to the first and second inner side-walls of the storage cabinet.

8. The vehicle-mounted reconfigurable storage tray of claim 3, further comprising:
first means for removably attaching the first mounting mechanism to the first side panel; and
second means for removably attaching the second mounting mechanism to the second side panel.

9. The vehicle-mounted reconfigurable storage tray of claim 8,
wherein the first means for removably attaching the first mounting mechanism to the first side panel is a first tray clip configured to receive a first threaded attachment mechanism inserted through a first panel hole; and
wherein the second means for removably attaching the second mounting mechanism to the second side panel is a second tray clip configured to receive a second threaded attachment mechanism inserted through a second panel hole.

10. A vehicle-mounted reconfigurable storage tray comprising:
a bottom panel including a tray surface on a first side of the bottom panel and a shelf surface parallel to the tray surface on a second side of the bottom panel;
two or more vertical panels attached to the bottom panel; and
one or more tray dividers configured to be removably attached to the vehicle-mounted reconfigurable storage tray extending upward from the bottom panel;
wherein the vehicle-mounted reconfigurable storage tray is configured to be mounted in either a tray position with the tray surface up or a shelf position with the shelf surface up.

11. The vehicle-mounted reconfigurable storage tray of claim 10, wherein the one or more tray dividers include a first tray divider, the vehicle-mounted reconfigurable storage tray further comprising:
a front divider clip removably affixed to a front panel and configured to receive a first end of the first tray divider; and
a back divider clip removably affixed to a back panel and configured to receive a second end of the first tray divider;
wherein the two or more vertical panels include the front panel and the back panel.

12. A vehicle-mounted reconfigurable storage tray comprising:
a bottom panel including a tray surface on a first side of the bottom panel and a shelf surface parallel to the tray surface on a second side of the bottom panel;
one or more sliding mechanisms on the bottom panel;
a pull-out drawer configured to slide along at least one of the one or more sliding mechanisms;
wherein the vehicle-mounted reconfigurable storage tray is configured to be mounted in either the tray position with the tray surface up or a shelf position with the shelf surface up.

13. The vehicle-mounted reconfigurable storage tray of claim 12, wherein the one or more sliding mechanisms includes a first sliding track mounted on the bottom panel, the pull-out drawer comprising:
a sliding rail that mates with the first sliding track allowing the pull-out drawer to slide in and out relative to the bottom panel.

14. The vehicle-mounted reconfigurable storage tray of claim 13, wherein the one or more sliding mechanisms includes a second sliding track mounted on the bottom panel and the sliding rail is a first sliding rail provided on a first side of the pull-out drawer, the pull-out drawer comprising:
a second sliding rail provided on a second side of the pull-out drawer that mates with the second sliding track allowing the pull-out drawer to slide in and out relative to the bottom panel.

15. A method of fabricating a vehicle-mounted reconfigurable storage tray comprising:
providing a bottom panel including a tray surface on a first side of the bottom panel and a shelf surface parallel to the tray surface on a second side of the bottom panel;
arranging a first side panel on the bottom panel, the first side panel including a first tray outer side-surface;
arranging a second side panel on the bottom panel, the second side panel being positioned parallel to the first side panel, wherein the second side panel includes a second tray outer side-surface;
arranging a back panel on the bottom panel;
wherein the vehicle-mounted reconfigurable storage tray is configured to be mounted in either the tray position with the tray surface up or a shelf position with the shelf surface up.

16. The method of fabricating a vehicle-mounted reconfigurable storage tray of claim 15, further comprising:
removably mounting a tray divider on the vehicle-mounted reconfigurable storage tray in a tray position;
arranging a front panel on the bottom panel;
affixing first drawer mounting hardware to a first inner surface of the first side panel; and
affixing second drawer mounting hardware to a second inner surface of the second side panel;
wherein the first drawer mounting hardware and the second drawer mounting hardware are configured to removably receive a compartmentalized drawer.

17. The method of fabricating a vehicle-mounted reconfigurable storage tray of claim 15, further comprising:
removably attaching a first mounting mechanism to the first side panel, the first mounting mechanism characterized by a first standoff distance and configured to be removably mounted on a first inner side-wall of a storage cabinet, the first inner side-wall being a stationary wall;
providing a first insertion tab extending from the first mounting mechanism and configured to bear a first weight portion of the vehicle-mounted reconfigurable storage tray, the first insertion tab configured to be inserted to at least an insertion depth into a first cabinet hole of the first inner side-wall of the storage cabinet;
removably attaching a second mounting mechanism removably attached to the second side panel, the second mounting mechanism characterized by a second standoff distance and configured to be removably mounted on a second inner side-wall of the storage cabinet, the second inner side-wall being a stationary wall; and
providing a second insertion tab extending from the second mounting mechanism and configured to bear a second weight portion of the vehicle-mounted reconfigurable storage tray, the second insertion tab configured to be inserted to at least the insertion depth into a second cabinet hole of the second inner side-wall of the storage cabinet.

18. The method of fabricating a vehicle-mounted reconfigurable storage tray of claim 17, further comprising:
cutting a first panel hole through the first side panel and a second panel hole through the second side panel;
wherein the storage cabinet is defined by a cabinet width measured between the first cabinet hole and the second cabinet hole;
wherein the vehicle-mounted reconfigurable storage tray has a tray width measured from the first tray outer side-surface at the first panel hole to the second tray outer side-surface at the second panel hole; and
wherein the tray width plus the insertion depth plus the first standoff distance plus the second standoff distance is greater than the cabinet width.

19. The method of fabricating a vehicle-mounted reconfigurable storage tray of claim 17,
wherein the first insertion tab comprises a flat surface configured to fit into the first cabinet hole, the first cabinet hole being an elongated slot; and
wherein the second insertion tab includes a flat surface configured to fit into the second cabinet hole, the second cabinet hole being an elongated slot.

20. The method of fabricating a vehicle-mounted reconfigurable storage tray of claim 19, wherein the bottom panel is planar; and
wherein the first cabinet hole is arranged on a slotted hole strip mounted on and considered part of the first inner side-wall of the storage cabinet.

21. The method of fabricating a vehicle-mounted reconfigurable storage tray of claim 17,
wherein the first mounting mechanism and the second mounting mechanism are 3D-fixed connector mechanisms configured to keep the vehicle-mounted reconfigurable storage tray stationary in all three dimensions with respect to the first and second inner side-walls of the storage cabinet.

22. The method of fabricating a vehicle-mounted reconfigurable storage tray of claim 17, further comprising:
removably attaching the first mounting mechanism to the first side panel with a first tray clip configured to receive a first threaded attachment mechanism inserted through a first panel hole; and
removably attaching the second mounting mechanism to the second side panel with a second tray clip configured to receive a second threaded attachment mechanism inserted through a second panel hole.

23. A method of fabricating a vehicle-mounted reconfigurable storage tray comprising:
providing a bottom panel including a tray surface on a first side of the bottom panel and a shelf surface parallel to the tray surface on a second side of the bottom panel;
arranging two or more vertical panels on the bottom panel; and
removably attaching one or more tray dividers to the vehicle-mounted reconfigurable storage tray extending upward from the bottom panel;
wherein the vehicle-mounted reconfigurable storage tray is configured to be mounted in either a tray position with the tray surface up or a shelf position with the shelf surface up.

24. The method of fabricating a vehicle-mounted reconfigurable storage tray of claim 23, wherein the one or more tray dividers include a first tray divider, the vehicle-mounted reconfigurable storage tray further comprising:
removably affixing a front divider clip to a front panel and configuring the front divider clip to receive a first end of the first tray divider; and
removably affixing a back divider clip to a back panel and configuring the back divider clip to receive a second end of the first tray divider;
wherein the two or more vertical panels include the front panel and the back panel.

25. A method of fabricating a vehicle-mounted reconfigurable storage tray comprising:
arranging a bottom panel including a tray surface on a first side of the bottom panel and a shelf surface parallel to the tray surface on a second side of the bottom panel;
mounting one or more sliding mechanisms on the bottom panel;
providing a pull-out drawer configured to slide along at least one of the one or more sliding mechanisms;
wherein the vehicle-mounted reconfigurable storage tray is configured to be mounted in either the tray position with the tray surface up or a shelf position with the shelf surface up.

26. The method of fabricating a vehicle-mounted reconfigurable storage tray of claim 25, wherein the one or more sliding mechanisms includes a first sliding track mounted on the bottom panel, the method comprising:
mounting a sliding rail on the pull-out drawer that mates with the first sliding track allowing the pull-out drawer to slide in and out relative to the bottom panel.

27. The method of fabricating a vehicle-mounted reconfigurable storage tray of claim 26, wherein the one or more sliding mechanisms includes a second sliding track mounted on the bottom panel and the sliding rail is a first sliding rail provided on a first side of the pull-out drawer, the method comprising:
mounting a second sliding rail on a second side of the pull-out drawer that mates with the second sliding track allowing the pull-out drawer to slide in and out relative to the bottom panel.
